(19) United States
(12) Patent Application Publication
(10) Pub. No.: US 2008/0047833 A1
(43) Pub. Date: Feb. 28, 2008

(54) Microfluidic device, measuring apparatus, and microfluid stirring method

(75) Inventors: Shuzo Hirahara, Yokohama-shi (JP); Kentaro Tani, Yaita-shi (JP); Haruyuki Minamitani, Yokohama-shi (JP)

Correspondence Address: KRATZ, QUINTOS & HANSON, LLP, 1420 K Street, N.W., Suite 400, WASHINGTON, DC, 20005, US

(73) Assignee: FLUID INCORPORATED,, Yokohama-shi (JP)

(21) Appl. No.: 11/802,419

(22) Filed: May 22, 2007

(30) Foreign Application Priority Data
May 26, 2006 (JP) 2006-146031
Mar. 6, 2007 (JP) 2007-056204

(51) Int. Cl. G01N 27/26

(52) U.S. Cl. 204/450; 204/600

(57) ABSTRACT

Conventionally, it has been difficult to effectively and promptly stir and mix fluids together by use of a microfluidic device having a simple flow path structure. Additionally, there has been no means for keeping a particulate sample floating in a fluid in a flow path for a long time without precipitating the particulate sample. Additionally, there has been no method for measuring the true size of a flowing and floating particulate sample by use of a microscope. The present invention solves these problems by using a microfluidic device in which an electrode pair having a wide electrode-to-electrode gap is formed in a flow path or in a chamber, and by applying an AC voltage to this electrode pair, and by generating an eddy by which a fluid is swirled in a torus manner. The accurate size of the particulate sample that crosses the in-focus plane can be measured especially by setting an in-focus plane (53) of an objective lens (52) of a microscope at a position through which a swirling flow (41) vertically passes.

### TECHNICAL FIELD

This invention relates to a microfluidic device that has micro-sized flow paths dug into a glass substrate or a plastic substrate so as to make an analysis or produce a reaction in the flow paths by use of small amounts of samples and, more specifically, to a microfluidic device that stirs and mixes liquids together while swirling the liquids in micro-sized flow paths dug into a glass substrate or a plastic substrate. Additionally, this invention relates to a microparticle-size measuring apparatus that measures the size of a particulate or aggregated sample that moves and floats in liquids while swirling the sample together with the liquids.

### BACKGROUND OF THE INVENTION

There is an inspection apparatus used to measure the size or the aggregated state of biological materials, such as cells or blood. For example, a platelet-aggregation inspecting apparatus based on the principle of a turbidimetric method shown in Non-Patent Document 1 has been widely used to quantitatively confirm a hemostatic capability. Through researches in recent years, an important intravital reaction relative to blood clots resulting from arteriosclerosis or diabetes has come to be known as starting from a small aggregate in which about several platelets to about a hundred platelets are gathered together. However, it has been pointed out that the turbidimetric method has the defect of being incapable of detecting this important area.

To overcome this defect, a scattered light method shown in Patent Document 1 has been developed, and detection sensitivity to detect small aggregates has been heightened. However, there is a need to always stir contents contained in a cuvette with a stirrer so that such aggregates do not sink or so that samples do not adhere to the wall of the cuvette. Additionally, to prepare about 1 cc of test specimens, there is a need to collect at least about 5 cc of blood before performing a test and to have time and a technique for preparing a sample from the blood.

To reduce the amounts of samples and save process steps, a method in which a microfluidic device is used has been proposed as shown in Patent Document 2. According to this method, whole blood is flowed along a micro-sized flow path, and the speed of the blood or the time at a specific position is measured. Since whole blood is used, time and steps required to prepare a sample are insignificant, and easy treatment can be achieved, hence making it possible to obtain many pieces of data, such as the influence of foods or stresses upon a blood state. However, since an especially thin structure having an inner diameter of about several micrometers is provided at a part occupying a place of the micro-sized flow path, a flow blockage is easily caused, and many test specimens are rejected as being untestable. Additionally, disadvantageously, the method shown in Patent Document 2 is inferior in accuracy and reliability, because, for example, a distribution having large width occurs in data obtained according to this method.

As described above, the microfluidic device used in the biological-material inspecting apparatus has two problems, one of which is that (1) flow blockage easily occurs in the flow path (which results from a microstructure) and the other of which is that (2) there is no means for stirring fluids in the flow path. From the viewpoint of preventing such a blockage, it is preferable to at least construct a general flow path having a width of from several tens of micrometers to several hundred micrometers, which is greater than a flow path having a width of several micrometers in the present situation. Additionally, a new technique capable of easily stirring fluids in such a micro-sized flow path has been expected to be developed.

On the other hand, the microfluidic device is characterized in that a diffusion-controlled chemical reaction is accelerated by a size effect, in that a slight amount of fluid is treated in a tightly-sealed state, hence in that environmental pollution can be prevented, in that a temperature-control response is swift, in that a reaction field having no temperature distribution can be obtained, and in that an unstable, explosive sample can be managed under safe environmental conditions. Therefore, the microfluidic device also has been highly expected as a microchemical reactor. However, disadvantageously, it is difficult to secure a necessary reaction time, because one of the restrictions imposed on the microfluidic device is that the flow path, which is a reaction field, is short.

To hasten the reaction time, “mixing” has been proposed or researched as shown in Patent Document 3 and Non-Patent Document 2. However, according to the mixing method shown in these documents, an even smaller structure is provided in the micro-sized flowpath, or a curved flow path is used. Therefore, the ununiformity of concentration or the adhesion of samples easily occurs. In particular, when a colloidal reaction product or a fine-particulate solid reaction product is obtained, the product is easily liable to be precipitated, and, disadvantageously, liable to cause a flow blockage.

Therefore, the microfluidic device used as a microchemical reactor has two problems, one of which is that (1) flow blockage easily occurs in a flow path (which results from a complicated structure) and the other of which is that (2) there is no means for stirring fluids in a flow path having a simple structure. These problems are the same as those of the biological-material inspecting apparatus mentioned above, and are fundamental ones common to the whole of the microfluidic device including many application fields.

Additionally, an optical microscope that is a simple and convenient observation instrument has not yet had a method for measuring the size of a biological material, such as cells, or a particulate reaction product that flows along a micro-sized flow path while floating therein. Disadvantageously, the reason is that the focal depth of the optical microscope is small, and an only slight variation, such as a variation by several micrometers, in the microscope-to-subject distance causes an optical blur, so that an accurate actual size cannot be grasped. Additionally, since only a part of the particles flowing through the cross-section of the flow path can be observed, it is difficult to inspect all of the particles, and there are many samples that pass therethrough without being measured.
[Patent Document 1] Japanese Unexamined Patent Application Publication No. H5-240863
[Patent Document 2] Japanese Unexamined Patent Application Publication No. H2-130471
[Patent Document 3] WO 2003/011443 (PCT/US2002/023462)
[Non-Patent Document 1] G. V. R. Born: “Aggregation of Blood Platelets by Adenosine Diphosphate and Its Reversal,” Nature, vol. 194, pp. 927-929 (1962)
[Non-Patent Document 2] K. Hosokawa, T. Fujii and I. Endo: “Handling of Picoliter Liquid Samples in a Poly(dimethylsiloxane)—Based Microfluidic Device, Analytical Chemistry, vol. 71, no. 20, pp. 4781-4785 (1999)
[Non-Patent Document 3] Nicolas G. Green, Antonio Ramos, Antonio Gonzalez, Antonio Castellanos, and Hywel Morgan: “Electro thermally induced fluid flow on micro electrodes,” Journal of Electrostatics, vol. 53, pp. 71-87 (2001)
[Non-Patent Document 4] Nicolas G. Green, Antonio Ramos, Antonio Gonzalez, Hywel Morgan, and Antonio Castellanos: “Fluid flow induced by nonuniform ac electric fields in electrolytes on micro electrodes. III. Observation of streamlines and numerical simulation,” Physical Review E, vol. 66, 026305 (2002)

### SUMMARY OF THE INVENTION

[Problems to be Solved by the Invention]

As described in the “background art,” a method in which an even smaller structure is provided in a flow path is used to perform a stirring operation or a mixing operation with a microfluidic device used in a biological-material inspecting apparatus or a microchemical reactor. However, a problem resides in the fact that the complicated structure or shape of the flowpath easily causes the occurrence of the ununiformity of concentration, the adhesion of samples or precipitates, and a flow blockage. Another problem resides in the fact that it is difficult to measure the size of a flowing and floating particulate material with a microscope.

[Means for Solving the Problems]

The microfluidic device of the present invention is characterized by including an electrode pair disposed to face each other in a horizontal plane in a micro-sized flow path or in a micro chamber, and is characterized in that an AC voltage is applied to the electrode pair, and a vertical upward flow is generated in the direction opposite to gravity with respect to a fluid whose electrical conductivity is 0.67 S/m or more at a position of an electrode-to-electrode gap of the electrode pair.

A flow swirling in the micro-sized flow path or in the micro chamber is induced by the vertical upward flow, and hence fluids can be promptly mixed together.

The electrode pair can be disposed on a floor side in the micro-sized flow path or in the micro chamber.

The electrode pair can be disposed on a ceiling side in the micro-sized flow path or in the micro chamber.

The measuring apparatus of the present invention is characterized by including the microfluidic device and an enlarging optical system that has an in-focus plane located in the vertical upward flow and at a position perpendicular to a flow line of the flow.

A size of a particulate material is measured by an apparent time-dependent change in the size of the particulate material in the in-focus plane, and hence the size of the particulate material can be accurately measured.

Additionally, the size of the particulate material can be accurately measured by measuring the fluorescent brightness of a particulate material in the in-focus plane.

The particulate material can be a biological material.

The particulate material can be a fluorescently-labeled biological material.

The particulate material can be a bead to which a biological material has been adhered or fixed.

The particulate material can be a bead to which a fluorescently-labeled biological material has been adhered or fixed.

The microfluid stirring method of the present invention is used for a fluid whose electrical conductivity is 0.67 S/m or more, and is characterized in that an AC voltage is applied to an electrode pair disposed to face each other in a horizontal plane in a micro-sized flow path or in a micro chamber, and in that a vertical upward flow is generated in the direction opposite to gravity with respect to a fluid whose electrical conductivity is 0.67 S/m or more at a position of an electrode-to-electrode gap of the electrode pair.

[Effects of the Invention]

Samples can be promptly stirred and mixed together, and, in addition, a floating particulate sample can be prevented from precipitating or adhering to the wall of the flow path by a means for generating a torus-shape swirling eddy in a simply-structured microfluidic device provided by the present invention. Accordingly, the floating particulate sample can be kept in a micro space for a long time in a floating state. The fluid swirling means makes it possible to improve the mixing performance of the microfluidic device and to widen the field of applications thereof.

Additionally, the size of a particulate sample floating and flowing in a fluid can be measured with a microscope by using the microfluidic device of the present invention together with the microscope. The microparticle-size measuring apparatus can be realized by this measuring means.

The present specification includes the contents described in the specification and/or drawings of Japanese Patent Application No. 2006-146031 and 2007-056204, which are the bases of priority of the present application.

### BRIEF DESCRIPTION OF THE DRAWINGS

FIG. 1 is a schematic sectional view showing an example of a fluid flow by a microfluidic device of the present invention.

FIG. 2 is a schematic sectional view showing another example of the fluid flow by the microfluidic device of the present invention.

FIG. 3A and FIG. 3B are schematic views of the microfluidic device of the present invention.

FIG. 4 is an image showing a torus-shape swirling flow.

FIG. 5 is an overall constitution view of a microparticle-size measuring apparatus of the present invention.

FIG. 6 is a plan view of a microfluidic device used in the microparticle-size measuring apparatus.

FIG. 7 is a schematic view showing the microfluidic device and a microscope.

FIG. 8 is an explanatory drawing for explaining the arrangement of a swirling flow and an objective lens.

FIG. 9 is an explanatory drawing for explaining an optical principle for measuring the size of a microparticle according to the present invention.

FIG. 10 is an explanatory drawing for explaining data processing performed to measure the size of a microparticle according to the present invention.

FIG. 11A, FIG. 11B, and FIG. 11C show a series of three frame images of video footage observed by a microscope.

FIG. 12A and FIG. 12B are schematic views of a microfluidic device of the present invention.

FIG. 13 is an image showing a mono-cylindrical swirling flow.

FIG. 14 is a plan view of a microfluidic device used in a microparticle-size measuring apparatus.

FIG. 15A, FIG. 15B, FIG. 15C, and FIG. 15D are cross-sectional comparative drawings showing a difference between a micro-sized flow path of the present invention and a conventional flow path.

FIG. 16 is a schematic view showing a microfluidic device and a microscope.

FIG. 17 is an explanatory drawing for explaining the arrangement of a swirling flow and an objective lens.

FIG. 18 is a one-frame image of video footage observed by a microscope.

FIG. 19 is a view showing an example of an apparatus in which a fluorescence microscope and the microfluidic device are combined together.

### BEST MODE FOR CARRYING OUT THE INVENTION

A detailed description will be hereinafter given of a method of forming a swirling flow in a microfluidic device according to the present invention.

### Embodiment 1

First, a description will be given of a swirling phenomenon of microfluids induced by electro hydrodynamic action, which is used in the present invention. A method using an electro thermal effect shown in Non-Patent Document 3 or a method using an AC electro-osmotic f low phenomenon shown in Non-Patent Document 4 is known as a method of swirling fluids in a micro-sized space.

The electro thermal effect is to use the nature of Joule heat that is generated by an alternating current being passed through fluids between electrodes and that causes temperature ununiformity (thermal gradient) in microfluids. Temperature ununiformity in fluids produces ununiformity between electrical conductivity and permittivity in the fluids, so that the fluids flow and swirl by effect of an electric-field force from an electrode pair that serves as a current-feed means and as an electric-field forming means.

The AC electro-osmotic flow is to use electrokinetic phenomena in which electric double layer ions (electric charges on the side of fluids) generated on an electrode surface slide on the electrode surface. The voltage supported by the electric double layer is a function of a distance from an opposite electrode and frequency. When a certain frequency is selected, a lateral electric field is generated even if on the electrode surface. Accordingly, ions (and fluids) flow, and liquids swirl.

Conventional research on these phenomena has only the report of experiments performed on the condition that the electrical conductivity of fluids is several tens of millisiemens per meter (mS/m) at the highest. In many experiments, a liquid having an even lower electrical conductivity was used. Additionally, in these experiments, torus-shape eddies were unable to be generated. Additionally, in these experiments, only an electrode pair having a narrow electrode-to-electrode gap less than several tens of micrometers (μm) was used.

However, if these phenomena are only used in these conditional ranges, its application will be limited, and it is difficult to produce general-purpose devices. For example, when biological materials are treated, a physiological saline or a liquid having an ion concentration substantially equal to that of the physiological saline is required. However, the physiological saline has an electrical conductivity of about 2 S/m, which corresponds to an electrical conductivity value greater by two to three orders than that of a liquid sample used in conventional experiments.

Additionally, a device having a conventional structure generates two cylindrical swirling eddies, each of which has the same size, on either side of an electrode gap. However, these two eddies into which a liquid has been divided are individually swirled, and hence do not move to each other. Therefore, this device is unsuitable for a purpose to mix liquids together.

The present inventors have made repeated experiments, and, as a result, have obtained the following new findings. First, the present inventors have confirmed that swirling phenomena occur in a solution having a concentration (about 0.9 wt %) of a physiological saline (whose electrical conductivity is 1.6 S/m) or a concentration greater than that of the physiological saline and, in addition thereto, that the swirling speed is increased in proportion to a rise in concentration. Accordingly, since swirling phenomena occur even in a solution whose electrical conductivity is, for example, 0.67 S/m or more, its capabilities can be fully realized with a physiological saline that is indispensable for medical use or bio-related purposes.

The swirling direction shown by the theories and experiments of the electro thermal effect of Non-Patent Document 3 and the AC electro-osmotic flow of Non-Patent Document 4 depends on a positional relationship between electrodes and a flow path. For example, in the electro thermal effect, when a voltage whose AC frequency is 7 MHz or less (which depends on the electrical conductivity) is applied to a liquid whose electrical conductivity is 0.01 S/m, the liquid present in a direction perpendicular to a plane formed by the electrode pair flows toward an electrode-to-electrode gap. When a voltage whose AC frequency is greater than 7 MHz is applied to this liquid, the liquid flows in an opposite direction. On the other hand, in the AC electro-osmotic flow, a liquid present in a direction perpendicular to a plane formed by the electrode pair always flows toward an electrode-to-electrode gap.

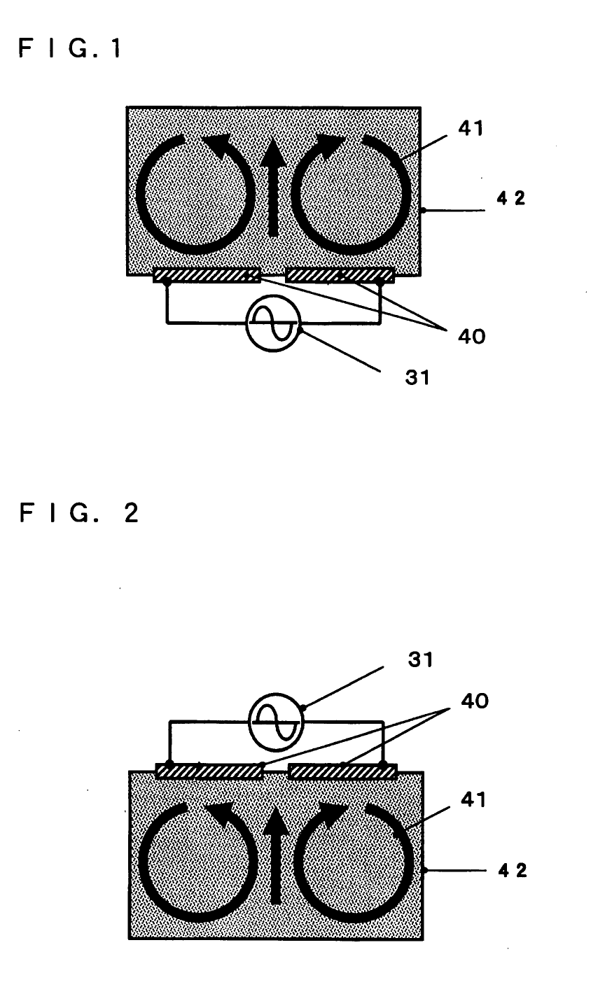

In contrast, a swirling flow used in the present invention appears in a liquid whose electrical conductivity is 0.01 S/m or more. If the liquid is present above an electrode-to-electrode gap, the liquid 41 flows in a direction away from the electrode-to-electrode gap (see FIG. 1), and, if the liquid is present below the electrode-to-electrode gap, the liquid 41 flows toward the electrode-to-electrode gap (see FIG. 2). FIG. 1 shows that an electrode pair 40 is disposed on a floor in a chamber 42, and, when an AC voltage is applied to the electrode pair 40 connected to an AC power source 31, the liquid flows in a direction away from an electrode-to-electrode gap. FIG. 2 shows that the electrode pair 40 is disposed on a ceiling in the chamber 42, and, when an AC voltage is applied to the electrode pair 40 connected to the AC power source 31, the liquid flows toward the electrode-to-electrode gap. Since the swirling direction of the flow found by the present inventors is not determined by the positional relationship between the electrodes and the flow path, this depends neither on the electro thermal effect nor on the AC electro-osmotic flow. This is induced by a buoyancy action that has been conventionally said to be negligible because the liquid always flows in the direction opposite to gravity, and hence is powerless in a microchannel. The temperature rise of a liquid required for the action of buoyancy is caused by supplying Joule heat generated by the resistance of a liquid between electrodes between which an electric current passes. Therefore, a liquid having a high electrical conductivity is required. The present invention is characterized in that a heat generating area is confined in a narrow space between the electrodes by using a liquid having such a high conductivity, and sufficient heat generation and a temperature difference are maintained even in, for example, the narrow space of a microchannel, thus allowing a strong buoyancy force to act there.

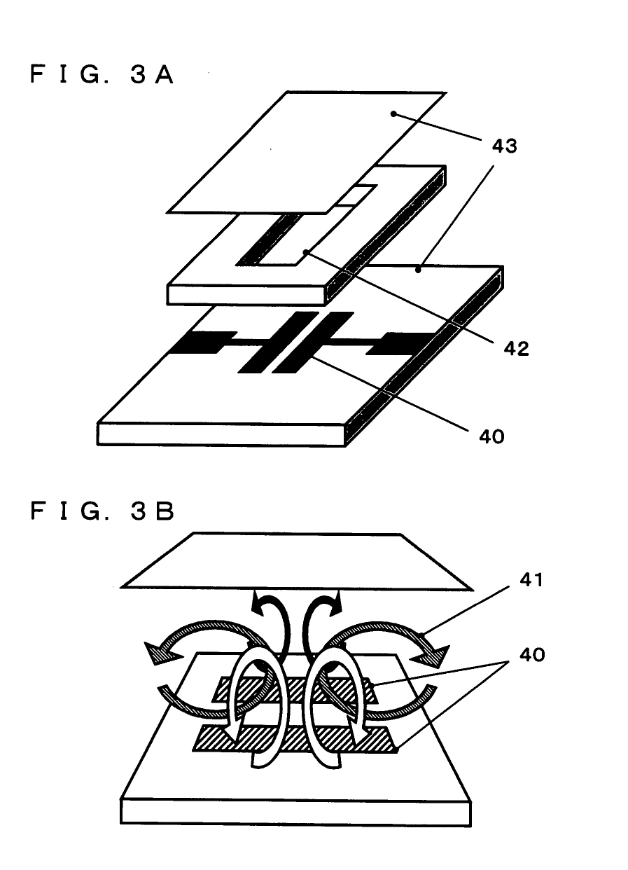

The following experiment was performed. In detail, a board was produced by patterning an electrode pair 40 having a wide electrode-to-electrode gap of 1 mm onto a surface of one of two glass substrates 43 shown in FIG. 3A. The board was then bonded with a 5 mm (width)×10 mm (length)×2 mm (height) chamber 42 which is a little large. As a result, the present inventors have found that a fluid swirls in a torus manner as shown in FIG. 3B.

Another example was performed by experimentally making a device in which only the electrode-to-electrode gap was changed. As a result, when the electrode-to-electrode gap was widened to a width of 2 mm, the swirling speed of the liquid was decreased to about 45%, and, when the electrode-to-electrode gap was widened to exceed 2 mm, the swirling speed thereof was sharply decreased. However, the present inventors have found that the unique property of hardly causing a change in the swirling speed is exhibited when the width of the gap is 1 mm or less.

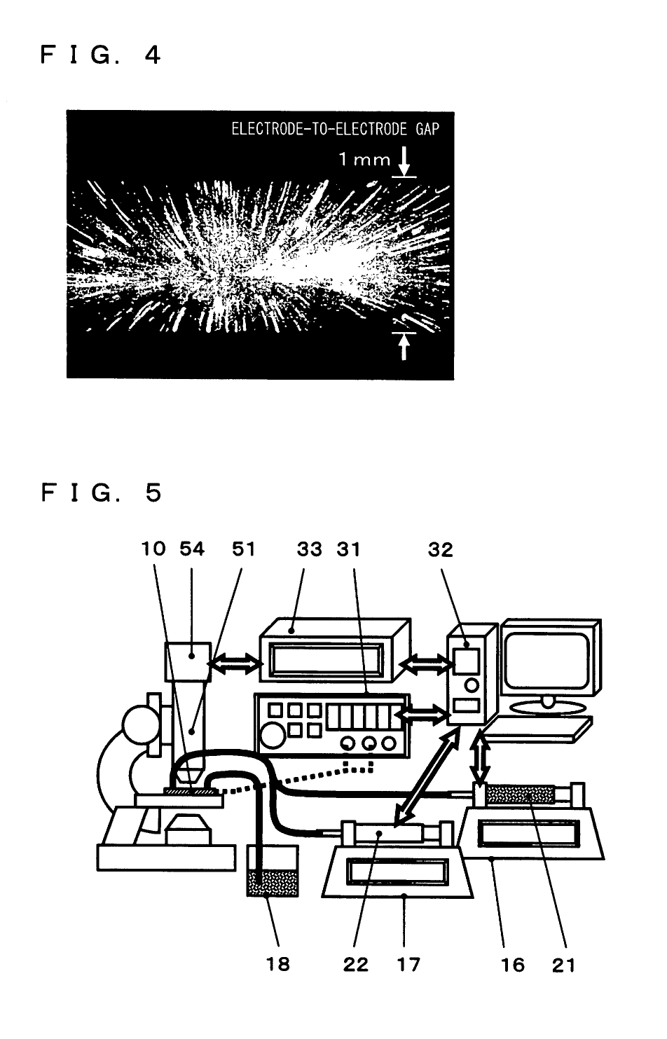

FIG. 4 shows an image obtained by photographing the interior of the chamber 42 through an electrode-to-electrode gap having a width of 1 mm from the side of an electrode plate. A sample is used in which an ADP (adenosine diphosphate) solution, which is a platelet-aggregating agent, has been added to a physiological saline solution of platelet cells fluorescently stained with FITC (fluorescein isothiocyanate). This image was processed so that the trajectory of the sample was able to be followed by superimposing 10-second frame images extracted from video footage taken while stirring and mixing were being performed for twenty minutes. From the image, it is seen that variously-sized platelet clumps swirl in a torus manner at a speed of about 500 μm/s, and a flow moving away in a vertical direction is formed at the center of the electrode gap.

The gist of the first embodiment of the present invention resides in the fact that electrodes having a wide gap therebetween are used as describe with reference to FIG. 3A and FIG. 3B, and that the electrode-to-electrode gap falls within a range of 100 μm to 2 mm. This range makes it easy to observe fluids with a microscope through the electrode-to-electrode gap. Additionally, this range makes it easy to allow a laser light to pass through the electrode-to-electrode gap, and is suitable for optical measurement, such as a laser light scattering method.

As described above, according to the present invention, it is possible to realize a microfluidic device capable of easily performing stirring and mixing operations in a micro-sized flow path having a simple structure without having a winding flow path or without providing special small juts in the flow path.

Additionally, the stirring and mixing operations performed by the microfluidic device of the first embodiment are not greatly affected by the presence or absence of a flow moving in the direction of the flow path. Therefore, it is permissible to use the device in a state in which a flow moving in the direction of the flow path is stopped. There are many biological materials used as samples each of which has a long reaction time. However, according to the present invention, such samples can be kept in the microfluidic device for a long time while being floated without causing precipitation in a flow stopping state.

Additionally, the microfluidic device of the first embodiment is characterized by being capable of obtaining a high swirling speed with a highly-concentrated solution, and has the advantage of being capable of fully showing its capabilities with a physiological saline that is indispensable for medical use or bio-related purposes. Additionally, the microfluidic device of the first embodiment is suitable for application to a microchemical reactor, because there are many chemical reactions in which the reaction velocity or the recovery efficiency of products is heightened when a highly-concentrated solution is used.

The present invention is applicable to all microfluidic devices capable of using the fluid-swirling electrodes mentioned in the above embodiment. The following description shows an embodiment applied to a microparticle-size measuring apparatus.

### Embodiment 2

FIG. 5 is an overall constitution view of a microparticle-size measuring apparatus using the microfluidic device including liquid-swirling electrodes according to the present invention. Herein, especially an example of the application to a platelet aggregation test is shown, and a description is given along the flow of a platelet sample 21 that is an object to be tested.

As a preprocess for the test, a platelet sample 21 of platelet-rich plasma (PRP) or platelet-poor plasma (PPP) is produced from the blood of a subject who has undergone 3.8% citric-acid blood drawing, and is incubated at 37° C. equal to the body temperature in a sample reservoir provided at a first liquid supply pump 16. On the other hand, 0.3 μM epinephrine is produced as a platelet-aggregating agent 22, and is set in a reservoir for the aggregating agent provided at a second liquid supply pump 17.

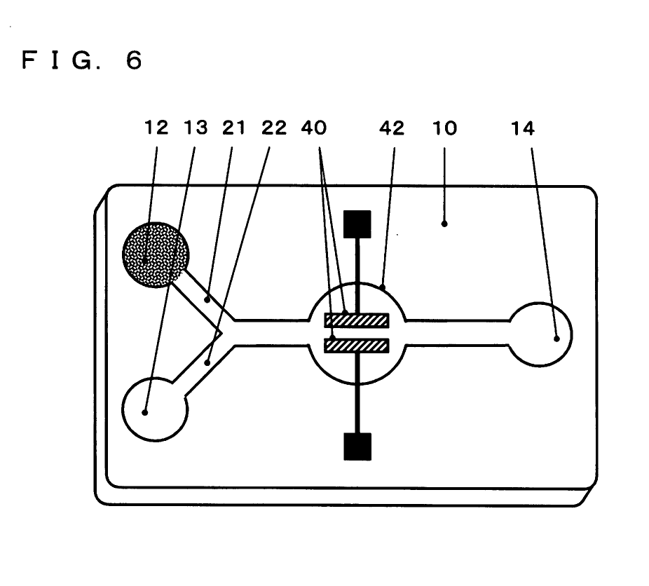

The test is started by actuating the first liquid supply pump 16. The platelet sample 21 is sent to a flow path of the microfluidic device 10 by the pressure from the liquid supply pump 16, and, at the same time, the platelet-aggregating agent 22 is sent to another flow path of the microfluidic device 10 from the second liquid supply pump 17. As shown in FIG. 6, the microfluidic device has a Y-shaped flow path therein. The platelet sample 21 and the platelet-aggregating agent 22 flow into the Y-shaped flow path from a first inlet 12 and a second inlet 13, respectively, and meet together to follow the same flow path.

The two sample solutions that have met each other flow downstream while maintaining a laminar flow state almost without being mixed together, and flow into a chamber 42 provided with an electrode pair 40. At this point, the platelet has not yet been activated, and adhesive power great enough to allow the platelet to adhere to the wall of the flow path or aggregation ability great enough to produce large aggregates has not yet appeared.

The electrode pair 40 having a wide electrode-to-electrode gap of, for example, 500 μm described with reference to FIG. 3A and FIG. 3B is disposed on the bottom face of the chamber 42. The chamber 42 is pre-filled with a physiological saline. The two liquid samples flowing into the chamber 42 from the inlet of the chamber 42 in a laminar flow state push the physiological saline out of an outlet 14 in such a manner as to replace the physiological saline filled in the chamber therewith. The physiological saline pushed out of the outlet 14 and a mixed solution of the platelet sample 21 and the platelet-aggregating agent 22 that has been tested are stored in a recovery container 18, and are discarded after the completion of a test. The first liquid supply pump 16 and the second liquid supply pump 17 sending the two sample solutions by pressure from the outside of the microfluidic device 10 stop being operated when the chamber 42 is substantially filled with the sample solutions. The AC power source 31, the liquid supply pumps 16 and 17, and a data collection and analysis device 33 described later are controlled by a process control device 32, by which the process and sequence of the whole of the apparatus are controlled.

An AC voltage is pre-supplied from the AC power source 31 to the electrode pair 40 disposed on the bottom face of the chamber 42 before the samples flow into the chamber. A swirling flow caused by the AC voltage applied to the electrode pair 40 stirs and mixes the platelet sample 21 and the platelet-aggregating agent 22 together. The platelets are gradually activated, and start being formed as small aggregates. The aggregates gradually become larger while being stirred for a further extended time. However, since the stirring operation is performed by the swirling flow, the platelets never adhere to the wall surface of the flow path even if the adhesive power thereof is increased, and large aggregates of the platelets never precipitate even if these are generated.

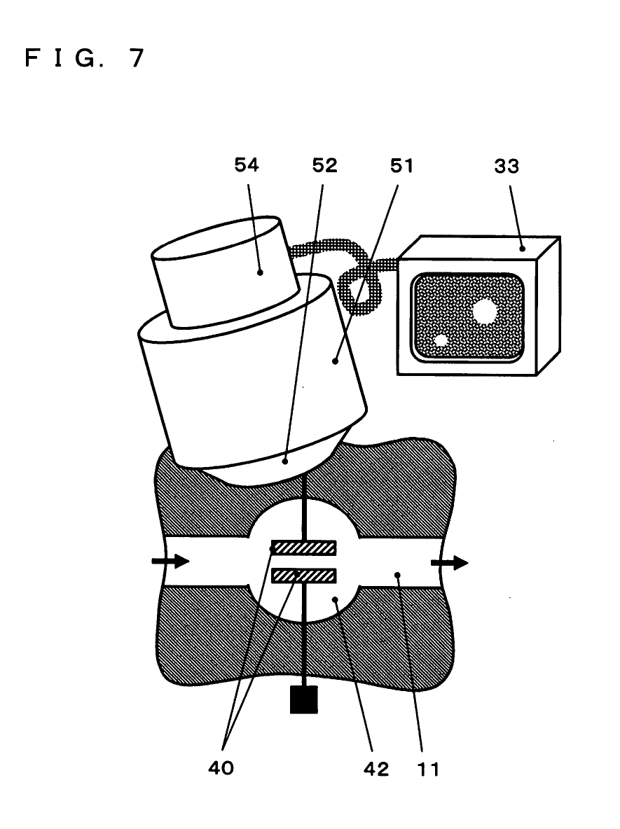

The measurement of a microparticle size that is an essential part of this embodiment is performed by employing a structure shown in FIG. 7. A particulate sample being in a flowing and floating state is observed with a microscope 51 disposed above the chamber 42. Images observed therewith are converted into video footage by means of a CCD camera 54, are then sent to the data collection and analysis device 33, and are subjected to image processing. The image processing produces results, such as the speed at which aggregates become larger with the lapse of time and the size distribution of aggregates.

In most cases, to measure the size of a micro-sized particulate material or the size of an aggregate of pieces of particulate material, a method has been conventionally employed in which a variation in the intensity of light passing through a sample solution or the scattered light intensity of a laser light is detected, so that those sizes are obtained as averaged data or statistical data. However, aggregates being increased in size with the lapse of time cannot be caught individually and microscopically. Additionally, it has been completely impossible to test all samples that have been input.

In this second embodiment, these problems are solved by employing the characteristic of the present invention described in the first embodiment, i.e., by employing the fact that a fluid in a microspace swirls while generating torus-shape eddies and by fixing the relationship between the position of an in-focus plane of an objective lens and the position of a swirling flow. A description will be hereinafter given of a method for measuring the size of a particulate sample or the size of an aggregate thereof.

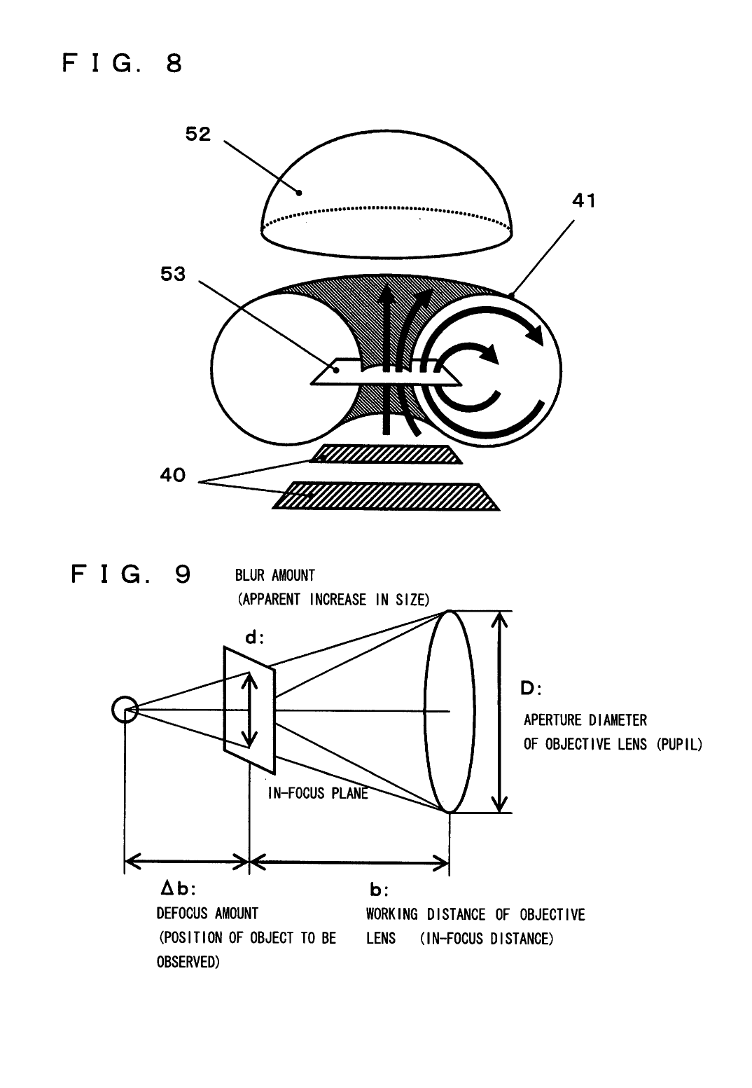

If an in-focus plane 53 of an objective lens 52 is set inside a circle serving as the center of a torus-shape swirling flow 41 as shown in FIG. 8, a particulate sample flowing and floating there passes through the in-focus plane 53 vertically. At this time, a particulate material suddenly appears as a large blurred image in a space on video footage observed through a microscope. The blurred image becomes smaller and clearer in proportion to an approach to the in-focus plane, and is again blurred after passing through the in-focus plane. As a result, on the video footage, the image is greatly blurred, and disappears therefrom.

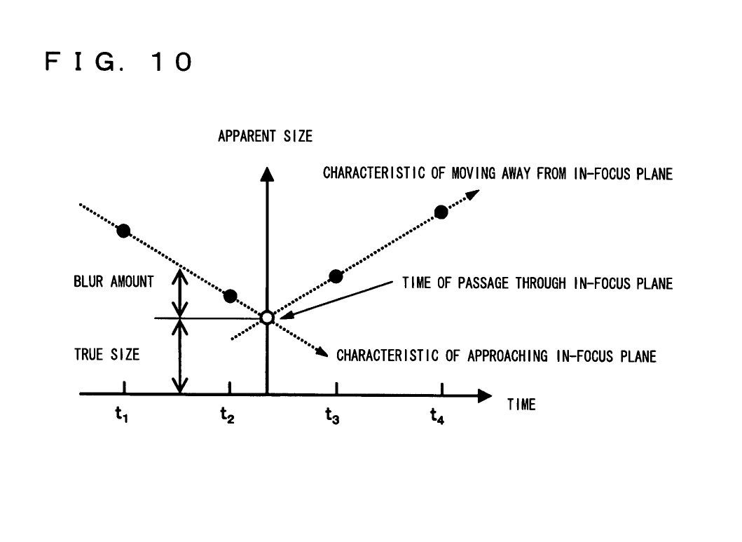

A relationship between the blur amount (d) of a blurred image and the defocus amount (Ab) can be easily calculated from geometrical optics as shown in FIG. 9, and can be expressed as d={Δb/(b+Δb)}D where D is the aperture diameter of an objective lens, and b is the working distance of the objective lens.

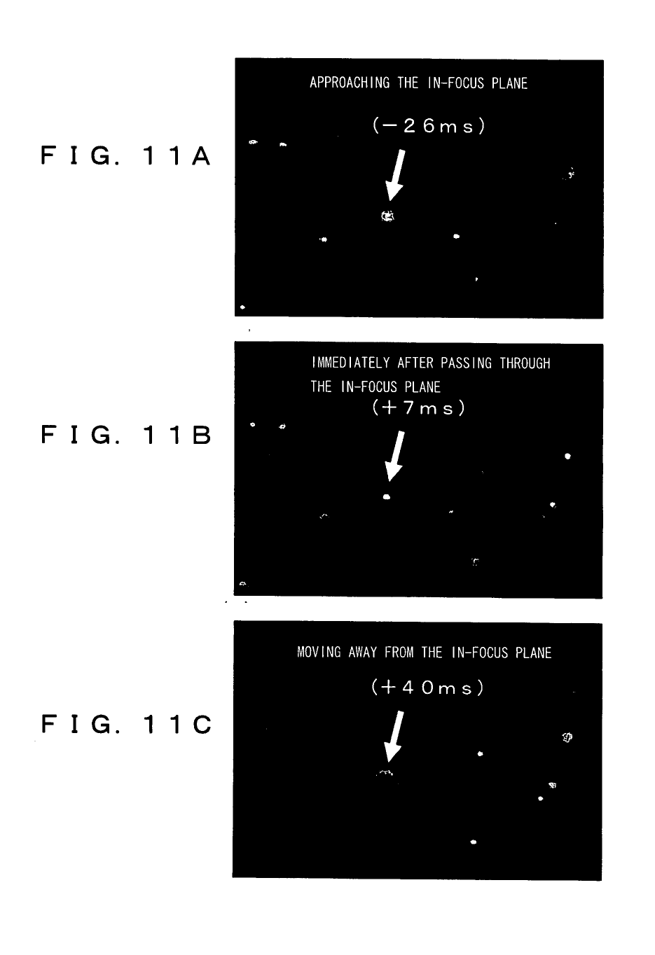

Therefore, as shown by a graph of FIG. 10, the apparent size of a particulate sample approaching the in-focus plane is changed in a monotone decreasing manner, i.e., is substantially rectilinearly changed with the lapse of time near the in-focus plane, and, at a certain point serving as a turning point, is changed in a monotone increasing manner, i.e., is substantially rectilinearly changed with the same inclination (reversed in the positive-negative relation) as in the monotone decreasing. From the intersection of the decreasing and increasing lines in the graph, it is possible to know the time at which the particulate sample has passed through the in-focus plane and the true size of the particulate sample.

Since frame images of the video footage are taken at intervals of 33 ms, the probability that a particulate sample will be photographed exactly at the position of the in-focus point is extremely low, and hence most images are in an optically blurred state. However, herein, the important thing is that if there are at least three pieces of data (corresponding to black circles of FIG. 10) concerning the apparent particle size that is increased or decreased at the in-focus point which is the turning point of the increase-decrease relation, the correct particle size (corresponding to the white circle of FIG. 10), the time at which the particle passes through the in-focus plane, and the particle speed shown when the particle passes through the in-focus plane can be estimated by applying the blur-amount expression mentioned above.

A series-of-images-processing algorithm is performed such that blurred images of a flowing and floating particulate sample are taken as video footage sampled in chronological order as described above, thereafter a threshold is determined and binarized according to the brightness of the blurred image, thereafter the apparent size is measured as an area on a screen, and the true size is estimated from a time-dependent change. This algorithm is programmed into the data collection and analysis device 33 of FIG. 5. Further, a statistical procedure is automatized in which pieces of data concerning each particle are gathered together, and the statistics of a size distribution and a time-dependent change thereabout are taken.

A series of three frame images obtained from an actual observation video are shown as an example in FIG. 11A, FIG. 11B, and FIG. 11C. Attention is paid to a particle indicated by an arrow in each frame image, and a blurred image thereof is analyzed by the procedure mentioned above. As a result, it is understood that, based on the time at which the particle passes through the in-focus plane, the images show −26 ms (when approaching the in-focus plane), +7 ms (immediately after passing through the in-focus plane), and +40 ms (when moving away from the in-focus plane), respectively, and hence the true particle diameter is 6.0 μm.

As can be understood from the blur-amount expression, the blur amount does not depend on the size of a particulate sample to be observed, and is a function only of the defocus amount. Therefore, a distance covered during a periodic frame interval of 33 ms can be calculated from a change in the blur amount per frame, and the speed of a swirling flow (i.e., the speed of the particle sample) can be measured. The value 720 μm/s is obtained in the example of FIGS. 11A, 11B and 11C.

The gist of this second embodiment resides, first, in the fact that a microfluidic device that generates a torus-shape swirling flow is used, secondly, in the fact that the in-focus plane of a microscope is positionally set to perpendicularly intersect the flow of a swirling and circulating fluid, and thirdly, in the fact that time-series several blurred images (at least three blurred images) are obtained by a means, such as video shooting, through the microscope. This process makes it possible to measure the size of a particulate sample flowing and floating in the microfluidic device by use of the microscope.

In this second embodiment, an example has been shown in which fluids are swirled in the chamber slightly larger than the micro-sized flow path. However, the present invention is not limited to the shape of the chamber. Even if the device includes electrodes and a flow path having several hundred micrometers, which is slightly larger than that of the above example, fluids can be swirled in a torus manner, and hence the present invention can be embodied by all of those structures.

In the second embodiment, a platelet aggregation test has been described as an example. However, according to the gist of the present invention, any type of device can be used as long as the purpose is to measure the size of a flowing and floating particle. For example, the device can be a microchemical reactor used to generate a particulate material as a result of a chemical reaction or a synthetic reaction in a micro-sized flow path. If such a device is used for this, conditions, such as synthesis time, can be controlled while always checking the size of a generated particle or size distribution, and process control and quality control can be easily achieved.

Additionally, in the second embodiment, a description has been given of the liquid supply of a pressure flow caused by the liquid supply pump. However, another method may be employed without being limited to the liquid supply of a pressure flow. For example, it is possible to employ a method in which a DC voltage is applied to electrodes provided at an inlet and an outlet, respectively, of a micro-sized flowpath, and a liquid is supplied by use of an electrophoresis or an electro-osmotic flow. This method never disturbs the object of the present invention. There is no interrelated influence between a swirling flow driven by an AC voltage and an electrophoresis or an electro-osmotic flow driven by a DC voltage, and a feature of the present invention is to enable these to act independently of each other.

In the second embodiment, as shown in FIG. 8, an example has been described in which an in-focus plane is set near an inner circle (inner line) of a torus formed by a swirling flow line. Besides, the position at which a flow becomes vertical exists at an outer circle (outer line), and it is possible to set an in-focus plane at either position. However, the inner circle has a dense flow line (i.e., high speed), and is the place at which the number of particles passing therethrough per unit area and per unit time becomes maximum. Therefore, it is also possible to measure all particulate flow samples in a swirling flow by covering the inner circle of all flow lines while adjusting the visual angle of the microscope.

### Embodiment 3

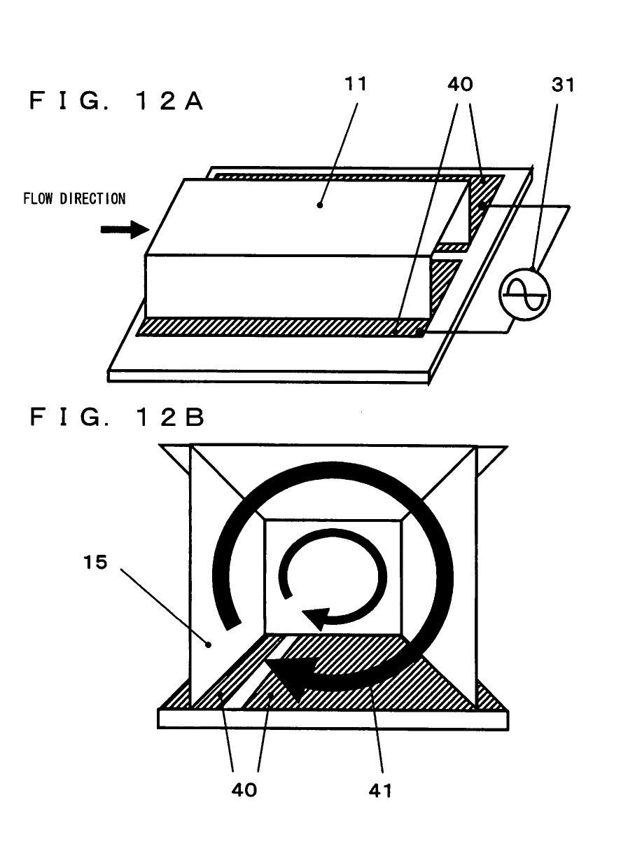

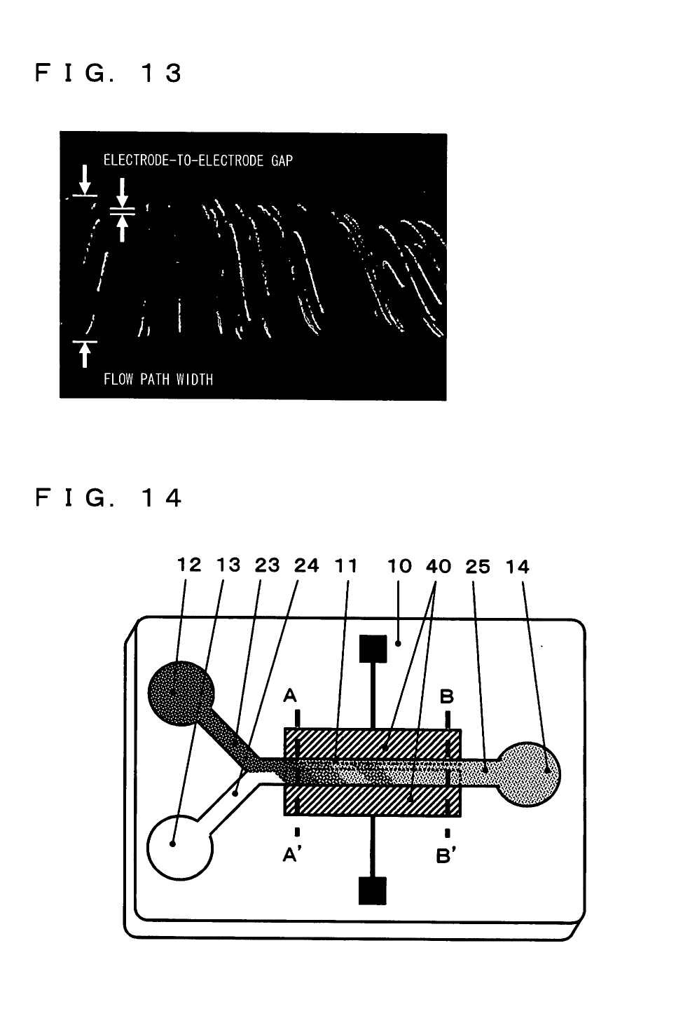

The next experiment was performed as follows. As shown in FIG. 12A and FIG. 12B, a micro-sized flow path was experimentally produced such that an electrode pair 40 consisting of electrodes facing each other at either side of the micro-sized flow path 11 was provided, and an electrode-to-electrode gap thereof was disposed at a position extremely near one wall surface 15 of the micro-sized flow path, i.e., at a left-right unsymmetrical position. A voltage was supplied from an AC power source 31. As a result, it has been found that the number of swirling eddies generated here is not two, but only one as shown in FIG. 12B.

FIG. 13 shows an image taken in an experiment in which fluorescent beads having a diameter of 6 μm was used as a sample, and a physiological saline was used as a liquid, and an AC voltage of 5 MHz and 20 Vp-p was applied. Image processing was performed by superimposing 13-second video frame images together so that the trajectory of the sample can be seen. From the movement of the fluorescent beads of this image, it is understood that the fluid flow is a single eddy that cylindrically swirls, and that its speed is about 100 μm/second.

The gist of the third embodiment of the present invention resides in the fact that electrodes having a straight band-shaped gap therebetween are disposed to be asymmetrical with respect to the center line of the cross section of the flow path as shown in FIG. 12A and FIG. 12B. In other words, it resides in the fact that the electrode-to-electrode gap of electrodes is not disposed at the position of the center line. The thus structured device is capable of generating a swirling flow to be turned into a cylindrical single eddy extending in the flow-path direction in the flow path.

As described above, according to the present invention, it is possible to realize a microfluidic device capable of easily performing stirring and mixing operations in a micro-sized flow path having a simple structure without having a winding flow path or without providing special small juts in the flow path.

Additionally, the stirring and mixing operations performed by the microfluidic device of this embodiment are not greatly affected by the presence or absence of a f low moving in the direction of the flowpath. Therefore, it is permissible to use the device in a state in which a flow moving in the direction of the flowpath is stopped. There are many biological materials used as samples each of which has a long reaction time. However, according to the present invention, such samples can be kept in the microfluidic device for a long time while being floated without causing precipitation in a flow stopping state.

Additionally, the microfluidic device of this embodiment is characterized by being capable of obtaining a high swirling speed with a highly-concentrated solution, and has the advantage of being capable of fully showing its capabilities with a physiological saline that is indispensable for medical use or bio-related purposes. Additionally, the microfluidic device of this embodiment is suitable for application to a microchemical reactor, because there are many chemical reactions in which the reaction velocity or the recovery efficiency of products is heightened when a highly-concentrated solution is used.

The present invention is applicable to all microfluidic devices capable of using the fluid-swirling electrodes mentioned in the above embodiment. The following description shows an embodiment applied to a microparticle-size measuring apparatus.

### Embodiment 4

FIG. 5 is an overall constitution view of a microparticle-size measuring apparatus using the microfluidic device including liquid-swirling electrodes according to the present invention. Herein, especially an example of the application to a platelet aggregation test is shown, and a description is given along the flow of a platelet sample 21 that is an object to be tested.

As a preprocess for the test, a platelet sample 21 of platelet-rich plasma (PRP) or platelet-poor plasma (PPP) is produced from the blood of a subject who has undergone 3.8% citric-acid blood drawing, and is incubated at 37° C. equal to the body temperature in a sample reservoir provided at a first liquid supply pump 16. On the other hand, 0.3 μM epinephrine is produced as a platelet-aggregating agent 22, and is set in a reservoir for the aggregating agent provided at a second liquid supply pump 17.

The test is started by actuating the first liquid supply pump 16. The platelet sample 21 is sent to a flow path of the microfluidic device 10 by the pressure from the liquid supply pump 16, and, at the same time, the platelet-aggregating agent 22 is sent to another flow path of the microfluidic device 10 from the second liquid supply pump 17. As shown in FIG. 14, the microfluidic device has a Y-shaped flow path therein. The platelet sample used as a first sample solution 23 and the platelet-aggregating agent used as a second sample solution 24 flow into the Y-shaped flow path from a first inlet 12 and a second inlet 13, respectively, and meet together to follow the same flow path.

The two sample solutions that have met each other flow downstream while maintaining a laminar flow state almost without being mixed together, and flow into an area provided with an electrode pair 40. At this point, the platelet has not yet been activated, and adhesive power great enough to allow the platelet to adhere to the wall of the flow path or aggregation ability great enough to produce large aggregates has not yet appeared.

An AC voltage is pre-supplied from the AC power source 31 to the electrode pair 40 before the samples flow thereinto. A swirling flow caused by the AC voltage applied to the electrode pair 40 stirs and mixes the platelet sample 21 and the platelet-aggregating agent 22 together. The platelets are gradually activated, and start being formed as small aggregates. The aggregates gradually become larger while being stirred for a further extended time. However, since the stirring operation is performed by the swirling flow, the platelets never adhere to the wall surface of the flow path even if the adhesive power thereof is increased, and large aggregates of the platelets never precipitate even if these are generated.

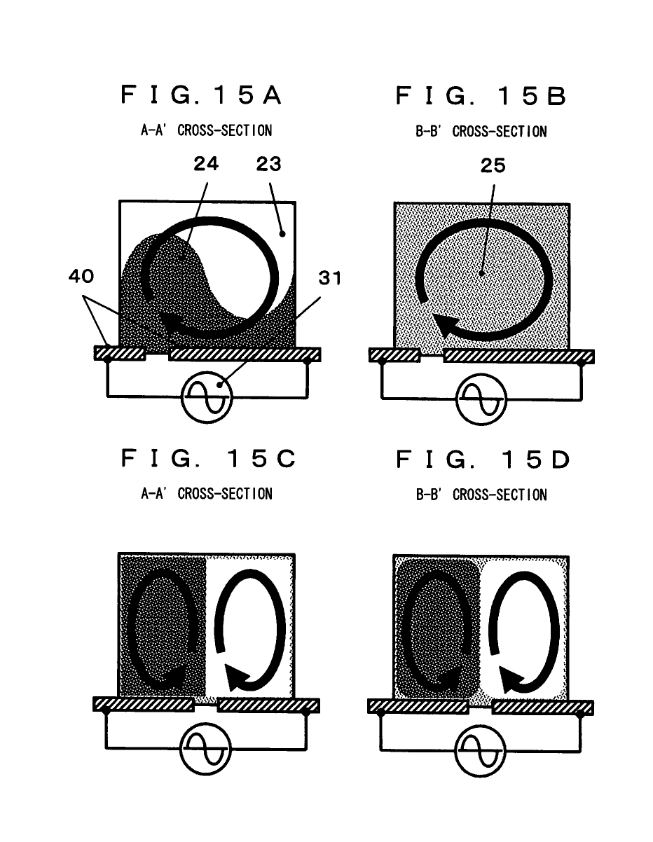

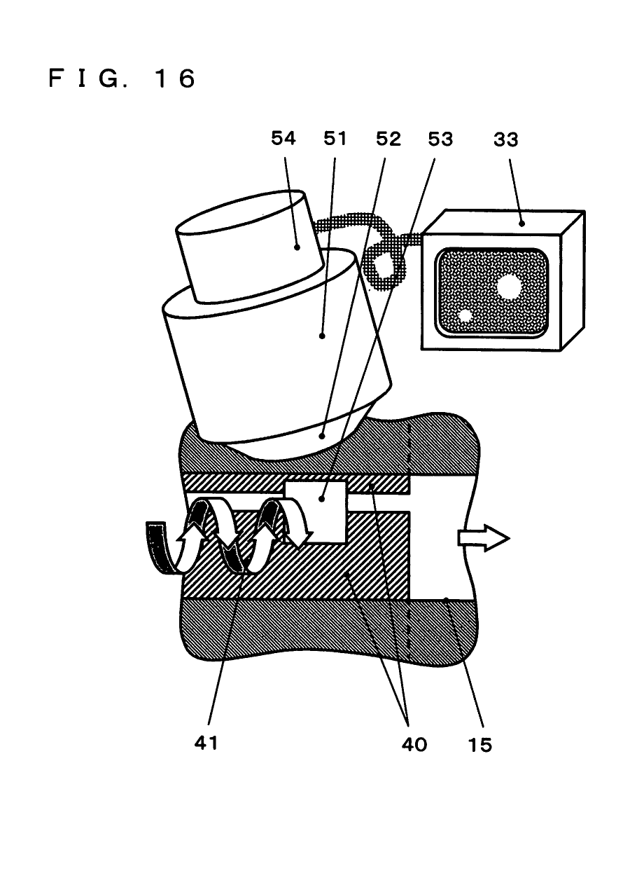

A description will be given of the effect of the stirring and mixing operations by the present invention while showing circumstances of the cross section of the flow path in a fore end area (A-A′) and a rear end area (B-B′) of the electrode pair 40. FIG. 15A and FIG. 15B show a case in which an electrode pair consisting of electrodes disposed asymmetrically according to the present invention is used. Since a swirling flow appearing as a single cylindrical eddy crosses the cross section of the flow path and rotates, the two sample solutions that have flowed thereinto in a laminar flow state are efficiently stirred and mixed together. On the other hand, in a conventional example in which an electrode-to-electrode gap is disposed at the center of a flowpath and in which electrodes are symmetrically arranged, two right-left eddies are generated as shown in FIG. 15C and FIG. 15D. Therefore, the two sample solutions flowing in a laminar flow state while being separated into right and left are individually swirled in a separated state, thus making it impossible to fulfill the mixing effect.

The measurement of a microparticle size that is an essential part of this embodiment is performed by employing a structure shown in FIG. 16. A particulate sample being in a flowing and floating state is observed with a microscope 51 disposed above the rear end area of the electrode pair 40. Images observed therewith are converted into video footage by means of a CCD camera 54, are then sent to the data collection and analysis device 33, and are subjected to image processing. The image processing produces results, such as the speed at which aggregates become larger with the lapse of time and the size distribution of aggregates.

In most cases, to measure the size of a micro-sized particulate material or the size of an aggregate of pieces of particulate material, a method has been conventionally employed in which a variation in the intensity of light passing through a sample solution or the scattered light intensity of a laser light is detected, so that those sizes are obtained as averaged data or statistical data. However, aggregates being increased in size with the lapse of time cannot be caught individually and microscopically. Additionally, it has been completely impossible to test all samples that have been input.

In this fourth embodiment, these problems are solved by employing the characteristic of the present invention described in the third embodiment, i.e., by employing the fact that a fluid in a microspace swirls while generating a cylindrical eddy and by fixing the relationship between the position of an in-focus plane of an objective lens and the position of a swirling flow. A description will be hereinafter given of a method for measuring the size of a particulate sample or the size of an aggregate thereof.

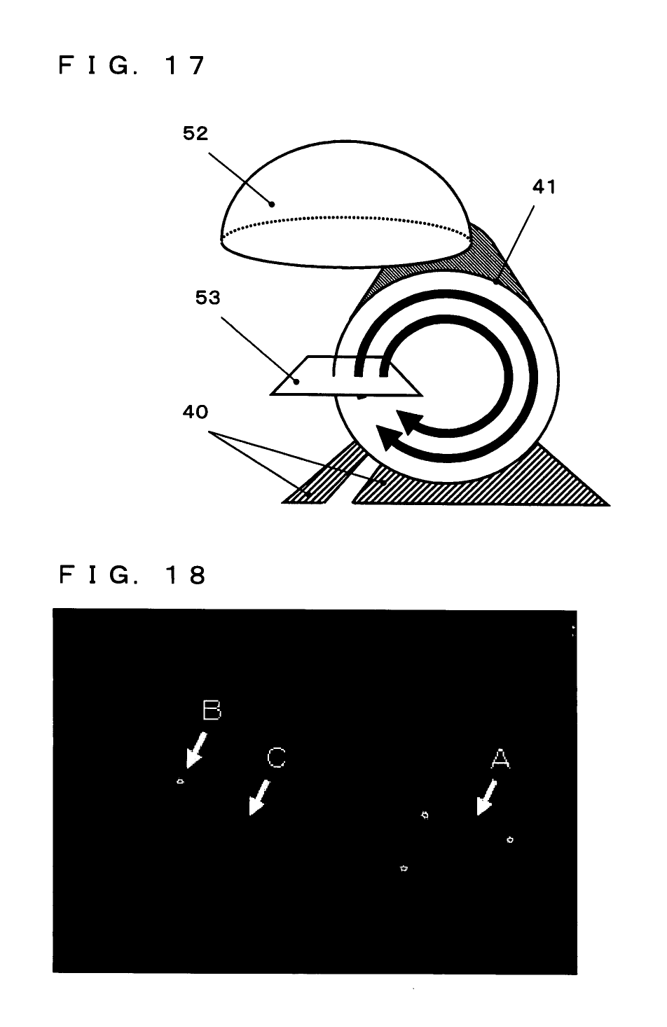

If an in-focus plane 53 of an objective lens 52 is set at substantially the same depth position as the position of the center of a cylindrical swirling flow 41 as shown in FIG. 17, a particulate sample flowing and floating there passes through the in-focus plane 53 vertically. At this time, a particulate material appears as a large blurred image in a space on video footage observed through a microscope. The blurred image becomes smaller and clearer in proportion to an approach to the in-focus plane, and is again blurred after passing through the in-focus plane. As a result, on the video footage, the image is greatly blurred.

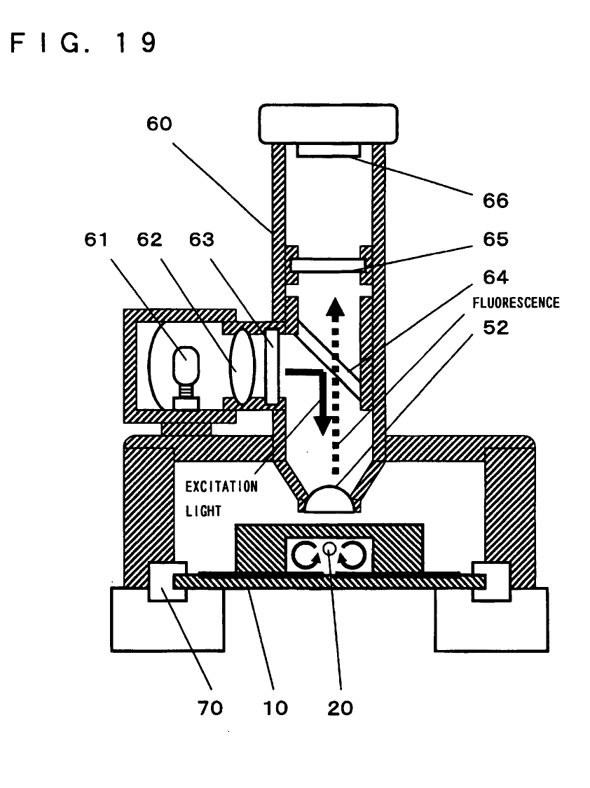

One frame image extracted from an actual observation video is shown as an example in FIG. 18. By comparison with frame images (not shown) before and after this one frame image, the data collection and analysis device 33 detects that a particle indicated by arrow A is approaching the in-focus plane, and a particle indicated by arrow B is substantially exactly on the in-focus plane, and a particle indicated by arrow C that has passed through the in-focus plane is moving away therefrom.

Attention was paid to the particle indicated by arrow B in the frame image of FIG. 18, and a blurred image thereof was analyzed by the procedure mentioned above. As a result, the following results were obtained. The diameter of this particle was 5.85 μm, and this particle occupied a position of 5.8 ms after passing through the in-focus plane, and the speed at which this particle passed though the in-focus plane was 98 μm/s.

The gist of this fourth embodiment resides, first, in the fact that a microfluidic device that generates a single cylindrical swirling flow is used, secondly, in the fact that the in-focus plane of a microscope is positionally set to perpendicularly intersect the flow of a fluid swirling in a micro-sized flowpath, and thirdly, in the fact that time-series several blurred images (at least three blurred images) are obtained by a means, such as video shooting, through the microscope. This process makes it possible to measure the size of a particulate sample flowing and floating in the microfluidic device by use of the microscope.

In the fourth embodiment, a platelet aggregation test has been described as an example. However, according to the gist of the present invention, any type of device can be used as long as the purpose is to measure the size of a flowing and floating particle. For example, the device can be a microchemical reactor used to generate a particulate material as a result of a chemical reaction or a synthetic reaction in a micro-sized flow path. If such a device is used for this, conditions, such as synthesis time, can be controlled while always checking the size of a generated particle or size distribution, and process control and quality control can be easily achieved.

Additionally, in the fourth embodiment, a description has been given of the liquid supply of a pressure flow caused by the liquid supply pump. However, another method may be employed without being limited to the liquid supply of a pressure flow. For example, it is possible to employ a method in which a DC voltage is applied to electrodes provided at an inlet and an outlet, respectively, of a micro-sized flowpath, and a liquid is supplied by use of an electrophoresis or an electro-osmotic flow. This method never disturbs the object of the present invention. There is no interrelated influence between a swirling flow driven by an AC voltage and an electrophoresis or an electro-osmotic flow driven by a DC voltage, and a feature of the present invention is to enable these to act independently of each other.

In the fourth embodiment, a description has been given on the assumption that a fluid flows while swirling in a spiral manner without being stopped in the direction of the flow path as shown in FIG. 16. However, according to the gist of the present invention, the flow speed in the direction of the flow path is not limited, and can be freely set. Therefore, process control can also be employed to stop a sample at a specific location in the flow path and allow the sample to continuously swirl at the same location for a long time. Additionally, all particulate samples flowing in the flow path can be measured by adjusting the flow speed in the direction of the flow path to the speed of a swirling flow and to the visual angle of the microscope.

### Embodiment 5

FIG. 19 shows an example of an apparatus formed by combining a fluorescent microscope 60 and the microfluidic device 10 together. A beam of light emitted from an excitation light source 61 is directionally adjusted by a condensing lens 62, and is filtered with an excitation light filter 63 so that only light having wavelengths needed to excite a fluorescent material used for the sample 20 can pass therethrough. The excitation light that has passed through the excitation light filter 63 and that has been reflected by a half mirror 64 is condensed on the focal plane of an objective lens 52, so that the fluorescence of a labeled substance adhering to the sample 20 passing through the focal plane is excited. A fluorescent image of the sample passes through the objective lens 52, passes through the half mirror 64, and passes through a fluorescent filter 65 that allows only the component of a fluorescent wavelength to pass therethrough, and reaches a CCD image device 66, where a fluorescent image enlarged to the magnification of the objective lens 52 is formed. An adaptor 70 used to detachably attach the microfluidic device is designed in consideration of the accuracy of the production specification of a fluorescent microscope and the microfluidic device so that the positional relationship between the fluorescent microscope 60 and the microfluidic device 10 is set to form a predetermined arrangement, in more detail, so that the position of the focal plane of the objective lens coincides with a predetermined depth position of the flow path in the microfluidic device. The present invention can be embodied by the thus structured apparatus, and size measurement can be performed by the thus structured apparatus.

### Embodiment 6

Conventionally, it has been difficult to determine an accurate size and brightness from fluorescence emitted from a particulate material. The reason is that a supporting material, such as a glass plate, that differs in refractive index from a medium into which sample particles are dispersed is provided near or in contact therewith, and hence a flare by multi reflection is generated, and an increase in beam of light and blur is caused.

According to the present invention, a fluorescing particle can be measured in a flowing and floating state, and a beam of light can be accurately measured in a state in which a material that will cause multi reflection is completely absent in the neighborhood.

If the measuring apparatus of the present invention is used, a small amount of chemical material or biological material in a solution can be easily detected and measured by combination with a reaction, such as an antigen-antibody reaction or an enzyme-protein reaction, that catches a unique material.

For example, a sample solution in which a biological material or the like to be measured by a competition method has been fluorescently labeled and a bead having a surface to which an antibody that adsorbs only a unique target material has been fixed are introduced into the microfluidic device of the present invention from different flow paths, respectively, and are mixed together, and the brightness of the surface of the bead is measured. As a result, a specific material can be detected and quantitatively analyzed.

Additionally, for example, a hydrophobic bead is mixed in a liquid medium in which fluorescently-stained platelets or fluorescently-stained white blood cells are floated, and, as a result, it becomes possible to perform an adhesive power test in which the amount of platelets or white blood cells that have adhered to the surface of the bead is detected with fluorescence.

Additionally, for example, a small amount of antigens can be detected and measured by an antigen-antibody reaction in which an antibody having an exclusive fluorescently-labeled part to which a target antigen has adhered is allowed to act on a particle having a surface to which an antibody has been fixed, and an ELISA (Enzyme-Linked ImmunoSorbent Assay) method can be performed for each particle.

Additionally, if a method is employed in which a material that reacts to and adsorbs different types of target material is fixed to beads having several kinds of sizes, and is mixed with a fluorescently-stained sample solution by a combination with the characteristic of the present invention of being capable of accurately measuring a size, a technique used as a microarray, i.e., a DNA microarray, a protein microarray, a cell microarray, or a compound microarray can be performed in a microchannel by use of the beads having different sizes instead of array coordinates. A test or an experiment can be performed by using only a slight amount of sample solution although it is inferior in number to a microarray using several hundred to several thousand array elements.

Additionally, in any brightness measurement mentioned above, a test or an experiment can be performed by only slight consumption by using a floating particulate substance in a microfluid even if the sample is valuable or even if the reagent is expensive. Additionally, since a particle is swirled in a microfluid, mixing by stirring can be accelerated, and a reaction time can be shortened.

All the publications, patents and patent applications cited in the present specification are taken in the present specification as references.

### INDUSTRIAL APPLICABILITY

As described above, the present invention realizes a microfluidic device suitable for the purpose of stirring and mixing samples together by using a torus-shape swirling flow formed in a simple structure. Additionally, the present invention realizes a microparticle-size measuring apparatus by using the characteristic of being capable of observing a particulate sample with a microscope from a direction in which the particulate sample being in a flowing and floating state flows. Additionally, the present invention realizes a microfluidic device suitable for the purpose of stirring and mixing samples together by using a single cylindrical swirling flow formed in a micro-sized flow path having a simple structure. In particular, since the present invention is superior in performance in a highly-concentrated solution, it is applicable to a biological-material inspecting apparatus that uses a physiological saline, such as an apparatus for a platelet aggregation test, or to a microchemical reactor that obtains a particulate reaction product from a highly-concentrated solution.

What is claimed is:

1. A microfluidic device for a fluid whose electrical conductivity is 0.67 S/m or more, said microfluidic device comprising:
an electrode pair disposed to face each other in a horizontal plane in a micro-sized flow path or in a micro chamber,
wherein an AC voltage is applied to said electrode pair and a vertical upward flow is generated in the direction opposite to gravity with respect to a fluid whose electrical conductivity is 0.67 S/m or more at a position of an electrode-to-electrode gap of said electrode pair.

2. The microfluidic device of claim 1, wherein a flow swirling in the micro-sized flow path or in the micro chamber is induced by said vertical upward flow.

3. The microfluidic device of claim 1, wherein said electrode pair is disposed on a floor side in the micro-sized flow path or in the micro chamber.

4. The microfluidic device of claim 1, wherein said electrode pair is disposed on a ceiling side in the micro-sized flow path or in the micro chamber.

5. A measuring apparatus comprising:
a microfluidic device for a fluid whose electrical conductivity is 0.67 S/m or more, said microfluidic device comprising: an electrode pair disposed to face each other in a horizontal plane in a micro-sized flow path or in a micro chamber, wherein an AC voltage is applied to said electrode pair and a vertical upward flow is generated in the direction opposite to gravity with respect to a fluid whose electrical conductivity is 0.67 S/m or more at a position of an electrode-to-electrode gap of said electrode pair; and
an enlarging optical system that has an in-focus plane located in said vertical upward flow and at a position perpendicular to a flow line of said vertical upward flow.

6. The measuring apparatus of claim 5, wherein a size of a particulate material is measured by an apparent time-dependent change in the size of the particulate material in the in-focus plane.

7. The measuring apparatus of claim 5, wherein said measuring apparatus measures the fluorescent brightness of the particulate material in the in-focus plane.

8. The measuring apparatus of claim 6, wherein said particulate material is a biological material.

9. The measuring apparatus of claim 6, wherein said particulate material is a fluorescently-labeled biological material.

10. The measuring apparatus of claim 6, wherein said particulate material is a bead to which a biological material has been adhered or fixed.

11. The measuring apparatus of claim 6, wherein said particulate material is a bead to which a fluorescently-labeled biological material has been adhered or fixed.

12. A microfluid stirring method for a fluid whose electrical conductivity is 0.67 S/m or more, said microfluid stirring method comprising:
applying an AC voltage to an electrode pair disposed to face each other in a horizontal plane in a micro-sized flow path or in a micro chamber; and
generating a vertical upward flow in the direction opposite to gravity with respect to the fluid whose electrical conductivity is 0.67 S/m or more at a position of an electrode-to-electrode gap of said electrode pair.
